(19) United States
(12) Patent Application Publication
(10) Pub. No.: US 2012/0038590 A1
(43) Pub. Date: Feb. 16, 2012

(54) TABLETOP INTERFACE SYSTEM AND METHOD THEREOF

(76) Inventors: JEE IN KIM, Seoul (KR); Young Seok Ahn, Seoul (KR); Jun Lee, Seoul (KR); Hyung Seok Kim, Guui 1-dong (KR); Min Gyu Lim, Gyeonggido (KR)

(21) Appl. No.: 12/972,422

(22) Filed: Dec. 17, 2010

(30) Foreign Application Priority Data
Aug. 12, 2010 (KR) 10-2010-0077654

(51) Int. Cl. G06F 3/042

(52) U.S. Cl. 345/175

(57) ABSTRACT

Provided is a tabletop interface system. A tabletop input device diffuses an infrared light emitted based on at least one touch input from a user. A tabletop output device allows the diffused infrared light to pass therethrough to display content information corresponding to at least one touch point. The tabletop recognition device recognizes the at least one touch point by generating a touch image data based on the infrared light passing through the tabletop output device and generates touch point information by using the touch image data. The content server transmits the content information, which corresponds to the touch point information received from the tabletop recognition device, to at least one content client application.

### CROSS-REFERENCE TO RELATED APPLICATIONS

The present application claims priority under U.S.C. 119 of Korean Patent Application No. 10-2010-0077654, filed on Aug. 12, 2010, the disclosure of which are expressly incorporated by reference herein in their entirety.

### BACKGROUND OF THE INVENTION

1. Field of the Invention

The present invention relates generally to a tabletop interface system and a method thereof and, more particularly to a technique which enables infrared rays to pass through a plurality of display panels, for example, liquid crystal display (LCD) panels, thereby producing a thin and large-sized system by utilizing a recognition system with a plurality of cameras, wherein a touch-input quality is improved by using a hybrid of a frustrated total internal reflection (FTIR) and a laser light plane (LLP) multi-touch input methods.

2. Description of the Related Art

Touch Interfaces are utilized in various fields to improve convenience for modern users who need to manage complex and busy everyday lives.

The feature of the touch interface is such that a user who is not familiar with a computing environment may easily use the touch interface by entering a touch input using the user's hand. Further, the touch interface is advantageous in that users can manipulate and control digital information by using a more intuitive method as compared to traditional input methods of using a keyboard or a mouse since a touch on a screen is recognized as an input.

The touch interfaces are used in various fields including, for example, Automated Teller Machines (ATMs) at banks, card charging machines at subway stations, restaurant ordering machines, Tablet Personal Computers (PCs), Personal Digital Assistants (PDAs), Portable Multimedia Players (PMPs), smart phones, mobile phones, and home equipment such as intercommunication systems, refrigerators and kitchen controllers to improve the quality of life.

A touch-based tabletop interface has been paid much attention and active development and research have been conducted thereon. The touch-based tabletop interface generally provides a wide touch region, and enables multiple users to simultaneously perform different tasks.

Therefore, since the touch-based tabletop interface facilitates collaborative and cooperative work among users, the touch-based tabletop interface is used in various fields, such as conference tables and exhibition tables as well as household tables. Representative examples of the touch-based tabletops include DigitalDesk, which is the first tabletop interface, Mitsubishi's DiamondTouch, and Microsoft Surface, which is shown in FIG. 1.

Recently, the tabletop interfaces have been in widespread use, and are installed in malls, exhibitions or restaurants for the purpose of promoting products or enabling a user to search and locate information.

Further, since direct interaction between users and digital information is available, tabletop interfaces have an advantage of actively inducing users who are not familiar with the computing environment. For this reason, tabletop interfaces can be utilized for a variety of purposes, such as in games, for entertainment, and for education as well as for computer-based technical work.

Therefore, studies have been performed to apply tabletop interfaces with educational entertainment contents for children or seniors who are not familiar with traditional interfaces, such as a keyboard or a mouse.

As described above, the purpose of utilizing the tabletop interface is to enable digital information to be manipulated and shared on a table, thereby increasing performance and efficiency of work when being performed by a plurality of users in a collaborative and cooperative way.

FIG. 2 shows people performing tasks on a table in an everyday life setting. Various types of table structures exist depending on the purpose of the table. For example, the table for multiple users in an office may have a structure such that users can sit up to the table. This structure provides a user-convenient environment to ease a user's long-hour desk job. Further, the tables can also function as a furniture, and recently tables have been developed such that they provide more convenient and multi-functions to users.

However, most of the existing structures of multi-touch tabletop interfaces that have been developed are inconvenient to be used as tables. Even the Microsoft Surface, which has been considered as the most successful product, has a structure in which a bottom space is closed, so that people are forced to do work while standing up or sitting in an inconvenient posture, thereby making it difficult to perform work over a long period of time.

FIG. 3 shows a box-shaped Microsoft Surface which is a multi-touch tabletop interface, wherein the bottom space of the table is closed. A structural problem is created due to the configuration of the system for recognizing multi-touch, and thus, most of the multi-touch tabletop interfaces have a problem due to configuring systems that have limited structures. This problem results in decreased work efficiency of users, contrary to the intended purpose of the tabletop interface.

Therefore, developing a system capable of providing a more convenient user-environment than that of a conventional system may be the most necessary and required part of developing the multi-touch tabletop interfaces.

### SUMMARY OF THE INVENTION

Accordingly, the present invention has been made in view of the above problems, and an object of the present invention is to provide a tabletop display system which enables infrared rays to pass through a plurality of display panels, for example, liquid crystal display (LCD) panels, wherein infrared rays are emitted in response to a user touch input through a hybrid of FTIR and LLP multi-touch input methods, thereby producing a wide and thin output system, and implementing a table-top display having a higher resolution and improved image quality.

Another object of the present invention is to provide a tabletop interface having a recognition system with a reduced height by configuring the recognition system to employ multiple cameras, thereby achieving a thin and large table system in which a plurality of users can share and perform real-time interaction, while the table system can also function as furniture.

Still another object of the present invention is to provide middleware for touch recognition and content interaction using a plurality of display units, for example, LCDs and a plurality of cameras, thereby providing flexibility and extensibility of a recognition system.

In one aspect of the present invention, a tabletop interface system according to the present invention includes: a tabletop input device configured to diffuse an infrared light emitted based on at least one touch input from a user; a tabletop output device configured to enable the diffused infrared light to pass therethrough to display content information corresponding to at least one touch point; a tabletop recognition device being configured to recognize the at least one touch point by generating a touch image data based on the infrared light passing through the tabletop output device and generate touch point information by using the touch image data; and a content server configured to transmit the content information, which corresponds to the touch point information received from the tabletop recognition device, to at least one content client application.

In another aspect of the present invention, a tabletop interface method according to the present invention includes: diffusing, by a tabletop input device, an infrared light emitted based on a touch input of a user; enabling, by a tabletop output device, the diffused infrared light to pass therethrough; recognizing, by a tabletop recognition device, at least one touch point of the user by generating a touch image data based on the infrared light, which passes through the tabletop output device, and generating touch point information based on the recognized touch point; and transmitting, by a content server, content information, which corresponds to the touch point information received from the tabletop recognition device, to the tabletop output device such that the content information is displayed to the user.

In still further aspect of the present invention, a user interface method using a tabletop display system according to the present invention includes: diffusing an infrared light emitted based on a touch input of a user such that the infrared light passes through a display unit of the tabletop display system; reflecting the infrared light passing through the display unit using a plurality of total reflection mirrors; generating touch point information by recognizing at least one touch point based on the reflected infrared light; and displaying content information corresponding to the touch point information.

In still further aspect of the present invention, a Liquid Crystal Display (LCD)-based tabletop interface system the present invention includes: a tabletop input device configured to receive a touch signal from a user using a Frustrated Total Internal Reflection (FTIR) input method and a Laser Light Plane (LLP) input method; a tabletop output device provided beneath the tabletop input device, configured to enable infrared light generated by the tabletop input device to pass therethrough, and configured to display content information corresponding to one or more touch points recognized by a tabletop recognition device; the tabletop recognition device provided beneath the tabletop output device, configured to recognize the touch points based on the touch of the user by generating infrared light, which is diffused by the tabletop input device and then passes through the tabletop output device provided beneath the tabletop input device, into touch image data; and a content server configured to transmit the content information, which corresponds to each piece of touch point information received from the tabletop recognition device, to one or more content client applications.

In still further aspect of the present invention, an LCD-based tabletop interface method based on the above-described system according to the present invention includes: (a) a tabletop input device diffusing infrared light emitted based on the touch input of a user; (b) a tabletop output device enabling the diffused infrared light to pass therethrough; (c) a tabletop recognition device recognizing one or more touch points of the user by generating the infrared light which passed through the tabletop output device into touch image data, and generating the recognized touch points into touch point information; and (d) a content server transmitting content information, which corresponds to each piece of the touch point information received from the tabletop recognition device, to the tabletop output device so that one of a plurality of LCD panels displays the corresponding content information.

### BRIEF DESCRIPTION OF THE DRAWINGS

The above and other objects, features and advantages of the present invention will be more clearly understood from the following detailed description taken in conjunction with the accompanying drawings, in which:

FIG. 1 illustrates a Microsoft Surface which is a tabletop interface;

FIG. 2 illustrates an example of people performing tasks on a table in an everyday life setting;

FIG. 3 illustrates an external appearance of the Microsoft Surface which is a tabletop interface having a box-shape and a closed bottom space;

FIG. 4 is a diagram showing an overall hardware (H/W) and software (S/W) of an LCD-based tabletop interface system according to the present invention;

FIG. 5 illustrates an infrared laser emitter of a tabletop input device of the LCD-based tabletop interface system according to the present invention;

FIG. 6 is a diagram showing a tabletop output device of the LCD-based tabletop interface system according to the present invention;

FIGS. 7A and 7B illustrate examples of a backlight lamp provided along respective edges of a plurality of light guide panels to enclose the light guide panels in the LCD-based tabletop interface system according to the present invention;

FIG. 8 is a diagram showing the tabletop recognition device of the LCD-based tabletop interface system according to the present invention;

FIG. 9 illustrates an example of a total reflection mirror of the LCD-based tabletop interface system according to the present invention;

FIG. 10 is a view showing a relationship among a touch recognition module, a content server and a content client module of the LCD-based tabletop interface-system according to the present invention;

FIG. 11 is a view showing touch information recognized by the touch recognition module of the LCD-based tabletop interface system according to the present invention, the touch information being rendered in Extensible Markup Language (XML) format;

FIG. 12 is a view showing a tabletop recognition device of the LCD-based tabletop interface system according to the present invention, the tabletop recognition device having a thickness of approximately 20 cm or less;

FIG. 13 is a diagram showing the content server of the LCD-based tabletop interface system according to the present invention;

FIG. 14A is a view showing a main execution screen of a food ordering content application connected to the content server of the LCD-based tabletop interface system according to the present invention;

FIG. 14B is a view showing an execution screen for food selection of the food ordering content application connected to the content server of the LCD-based tabletop interface system according to the present invention;

FIG. 14C is a view showing an actual execution of the food ordering application of the food ordering content application connected to the content server of the LCD-based tabletop interface system according to the present invention;

FIG. 15A is a view showing a main execution screen of a puzzle matching game application connected to the content server of the LCD-based tabletop interface system according to the present invention;

FIG. 15B is a view showing users who enjoy the game using the puzzle matching game application connected to the content server of the LCD-based tabletop interface system according to the present invention;

FIG. 16A is a view showing a touch recognition processing time in the LCD-based tabletop interface system according to the present invention;

FIG. 16B is a view showing the puzzle matching game application, which receives a touch input and performs a dragging operation in the LCD-based tabletop interface system according to the present invention;

FIG. 16C is a graph showing a recognition processing time based on input methods of the LCD-based tabletop interface system according to the present invention;

FIG. 16D is a graph showing an average recognition processing time based on the input methods of the LCD-based tabletop interface system according to the present invention;

FIG. 17 is a flowchart showing an LCD-based tabletop interface method according to the present invention;

FIG. 18 is a flowchart showing detailed processes of step S300 of the LCD-based tabletop interface method according to the present invention; and

FIG. 19 is a flowchart showing detailed processes of step S400 of the LCD-based tabletop interface method according to the present invention.

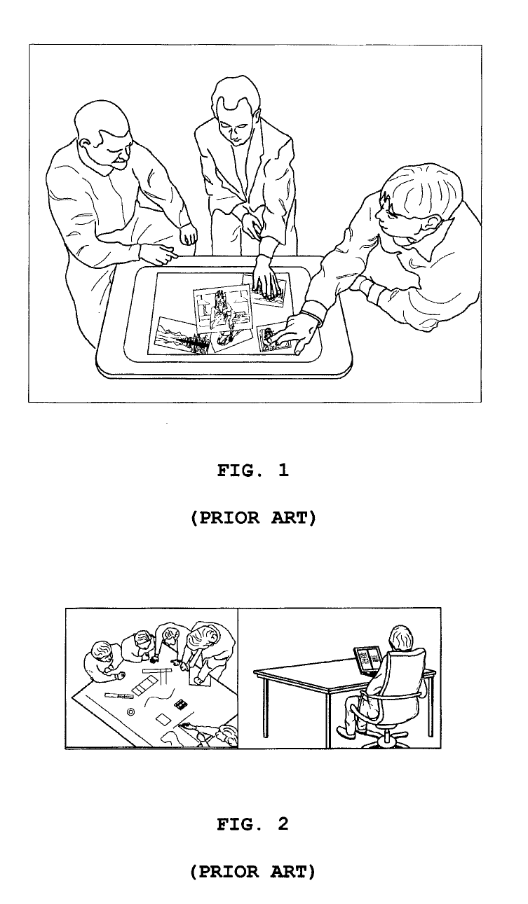

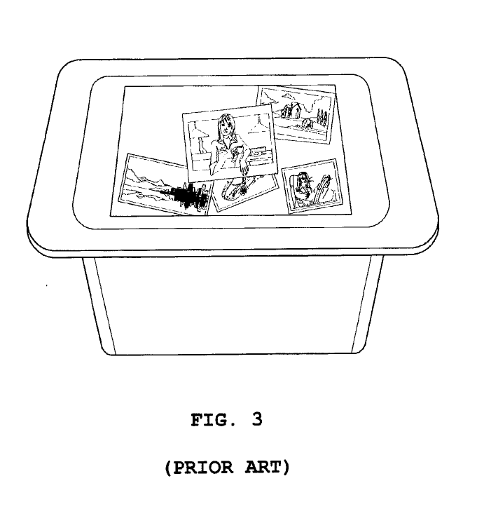

### DESCRIPTION OF THE PREFERRED EMBODIMENTS

The detailed features and advantages of the present invention will be more clearly understood from the following detailed description taken in conjunction with the accompanying drawings. Herein, terms and words used in the present specification and claims should be interpreted as having meanings and concepts in conformity with the technical spirit of the present invention based on the principle by which an inventor can appropriately define the concepts denoted by terms in order to describe the inventor's own invention in the most appropriate way. Further, it should be noted that, in the following description, when it is determined that the detailed descriptions of well-known functions and configurations related to the present invention would obscure the gist of the present invention, they may be omitted.

For illustrative purposes, it is assumed that a tabletop interface system according to the present invention employs a liquid crystal display (LCD). However, it should be noted that the tabletop interface system according to the present invention may include any other type of display.

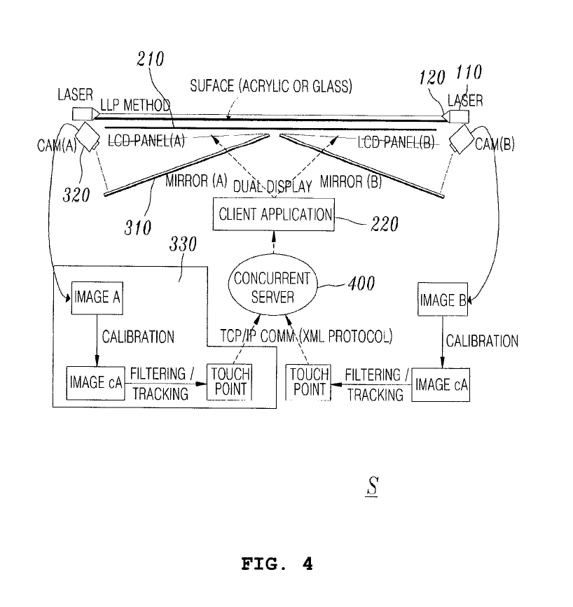

As shown in FIGS. 4 to 16D, an LCD-based tabletop interface system ‘S’ according to the present invention includes a tabletop input device 100, a tabletop output device 200, a tabletop recognition device 300, and a content server 400.

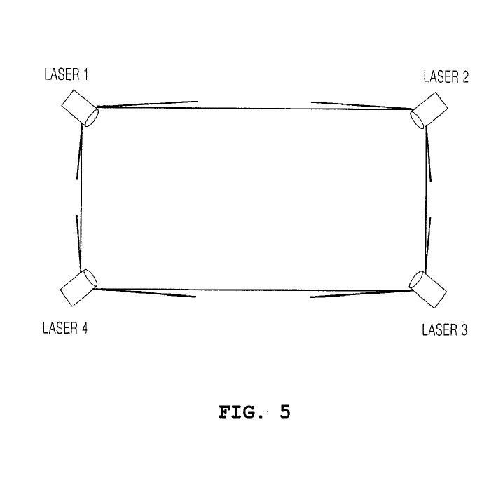

First, the tabletop input device 100 of the LCD-based tabletop interface system ‘S’ according to the present invention will be described below with reference to FIGS. 4 and 5.

Referring to FIG. 4, the tabletop input device 100 has a rectangular or square shape and receives a user touch signal in a frustrated total internal reflection (FTIR) or a laser light plane (LLP) input method. The tabletop input device 100 includes an acrylic of 10 T and infrared Light Emitting Diodes (LEDs) in order to realize the FTIR input method, and includes a plurality of infrared laser emitters 110 and a plurality of line generators 120 at each of edges thereof in order to realize the LLP input method, as shown in FIG. 5.

Each of the infrared laser emitters 110 emits infrared light of about 800 nm to about 900 nm, preferably, about 850 nm, and each of the line generators 120 diffuses the infrared light emitted by the infrared laser emitter 110 in the form of a line to have an angle between about 100° and about 110°, preferably, about 106°.

Here, the line generator 120 is spaced apart from an upper surface of the tabletop output device 200 by about 1 mm to about 5 mm, preferably, about 2 mm, and configured to diffuse the infrared light.

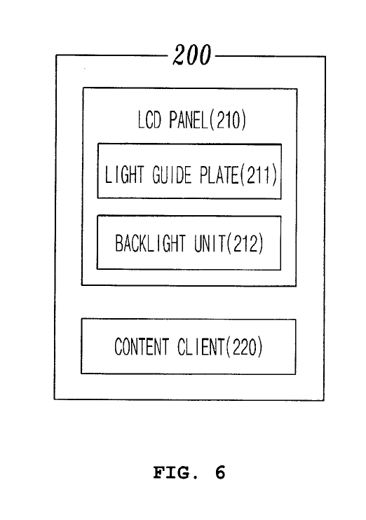

Meanwhile, the tabletop output device 200 of the LCD-based tabletop interface system ‘S’ according to the present invention will be described below with reference to FIG. 6.

The tabletop output device 200 is positioned lower than the tabletop input device 100, configured to enable the infrared light diffused by the tabletop input device 100 to pass therethrough, and configured to display content information corresponding to at least one touch point recognized by the tabletop recognition device 300. The tabletop output device 200 includes a plurality of LCD panels 210 and one or more content clients 220. The LCD panel 210 includes one or more light guide panels 211 and a plurality of backlight units 212 configured such that infrared rays pass therethrough.

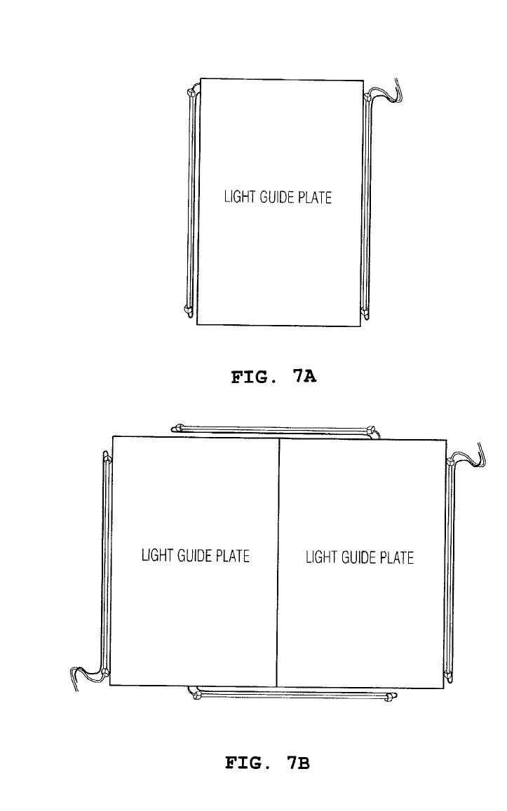

In detail, each of the LCD panels 210 includes a plurality of light guide panels 211 formed in a square or rectangular shape, and enables the infrared light diffused by the tabletop input device 100 to pass therethrough. While only one light guide panel 211 is used in FIG. 7A, in FIG. 7B, two of the light guide panels 211 adhere closely to each other, and the backlight units 212 are provided to cover a part of an outside surface of the plurality of light guide panels 211.

Further, each of the content clients 220 receives content information corresponding to touch point information from the content server 400, and allows the LCD panel 210 to display the corresponding content information.

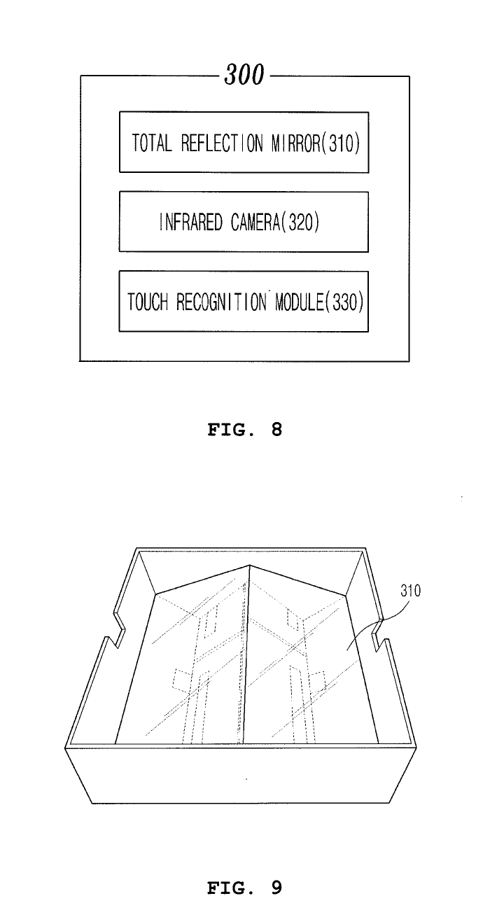

Meanwhile, the tabletop recognition device 300 is positioned lower than the tabletop output device 200. The infrared light generated by the tabletop input device 100 passes through the output device 200, and is generated into touch image data by multiple cameras of the recognition device 300, so that a touch point location, i.e., a position touched by a user is recognized. The tabletop recognition device 300 includes a plurality of total internal reflection mirrors 310, a plurality of infrared cameras 320 and a plurality of touch recognition modules 330, as shown in FIG. 8.

In detail, each of the total reflection mirrors 310 is spaced apart from a lower portion of the LCD panel 210 of the tabletop output device 200, and configured to reflect the infrared light passing through the LCD panel 210. Here, the total reflection mirror 310 has an angle ranging from about 25° to about 35°, preferably, about 30° relative to a lateral frame of the tabletop, as shown in FIG. 9.

Further, each of the infrared cameras 320 is positioned lower than the LCD panel 210, and is configured to generate touch image data by recognizing the infrared light reflected by the total reflection mirror 310, and is configured to include a wide-angle lens having a rotational angle ranging from about 100° to about 120°, preferably, about 116°, in order to recognize infrared light coming from a wide range of areas.

Here, the infrared camera 320 is formed to have an angle ranging from about 40° to about 50°, preferably, about 45°, relative to a vertical frame of the table top, so that a single infrared camera 320 can cover more than half of the entire LCD panel 120 (a single LCD panel of 26 inches).

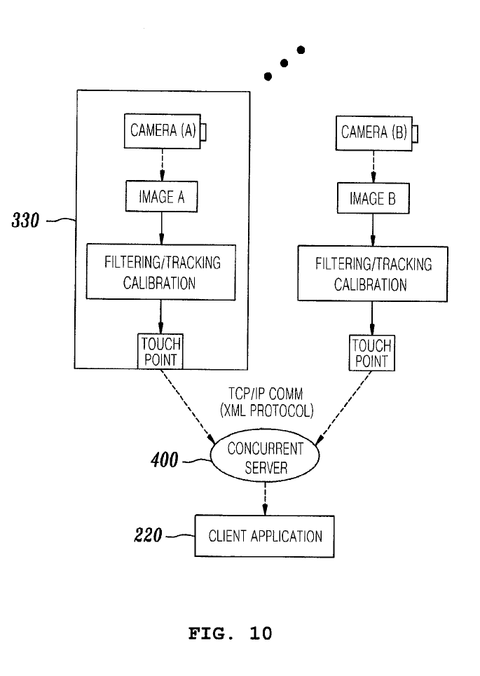

Further, as shown in FIG. 10, each of the touch recognition modules 330 filters out noise included in the touch image data received from one of the plurality of the infrared cameras 320 using a Community Core Vision (CCV) library, recognizes touch points by tracking the coordinates of the touch image whose noise has been removed and by performing calibration for correcting the coordinates, and transmits touch point information generated by the recognition to the content server 400 accessed via an information network. Here, the plurality of the touch recognition modules 330 transmits a plurality of pieces of touch point information, which is generated based on the touch image data received from the plurality of the infrared cameras 320, to the content server 400. That is, the touch recognition modules 330 are provided in plural to correspond to the number of the infrared cameras 320, so that each of the touch recognition modules 330 can recognize a touch point for the touch image data received from the corresponding infrared camera 320.

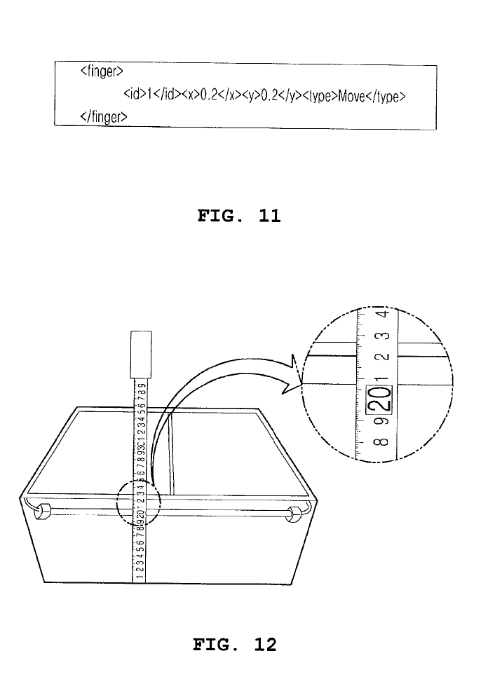

Further, the touch recognition module 330 processes the generated touch point information in XML format and transmits the resulting touch point information to the content server 400. FIG. 11 is an example view showing the touch point information recognized by the touch recognition module 330 and processed in XML format.

Referring to FIG. 11, an ‘id’ field denotes the unique ID number of the corresponding touch input, an ‘x’ and a ‘y’ fields denote coordinates of the touch point information obtained by performing calibration, and a ‘type’ field includes ‘Down’, ‘Move’, and ‘Up’ messages, which are generated based on previous and current touch point information in the CCV library. The concept of ‘Down’ and ‘Up’ messages is comparable to a mouse click, and indicates an event of a user's initial touch occurring or terminating. In case of a dragging operation, the dragging state of a current user is tracked using the unique ID number and the ‘Move’ message of the ‘type’.

As described above, the tabletop recognition device 300 is produced to include a plurality of LCD panels 210, the total reflection mirrors 310 each having an angle of about 30°, and the infrared cameras 320 each having an angle of about 45° and having a rotational angle of about 116°. Therefore, as shown in FIG. 12, the thickness of the tabletop recognition device 300 can be made to be about 20 cm or less.

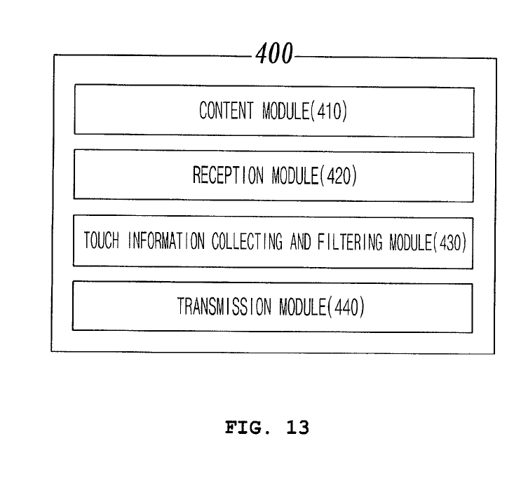

Meanwhile, the content server 400 of the LCD-based tabletop interface system according to the present invention will be described with reference to FIG. 13 below.

The content server 400 receives the touch point information from the tabletop recognition devices 300 accessed via the information network, and transmits the content information which corresponds to each piece of the touch point information to a content client application. The content server 400 includes a connection module 410 for connecting the touch recognition module 330 of the tabletop recognition device 300 with a content client, a reception module 420, a touch information collecting and filtering module 430, and a transmission module 440.

First, the connection module 410 connects the touch recognition module 330 corresponding to the touch point information with the content client application.

Further, the reception module 420 receives touch point information corresponding to the touch input of a user from the touch recognition module 330 of the tabletop recognition device 300 via the information network, for example, a Transmission Control Protocol (TCP) or a User Datagram Protocol (UDP).

In addition, the touch information collecting and filtering module 430 collects and filters the touch point information received from the touch recognition module 330 of the tabletop recognition device, and the transmission module 440 transmits content information to the content clients 220. The content information is classified so that it corresponds to the collected and filtered touch point information.

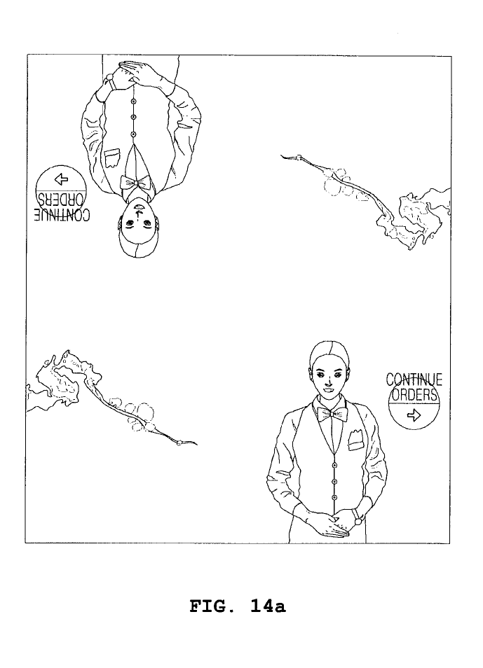

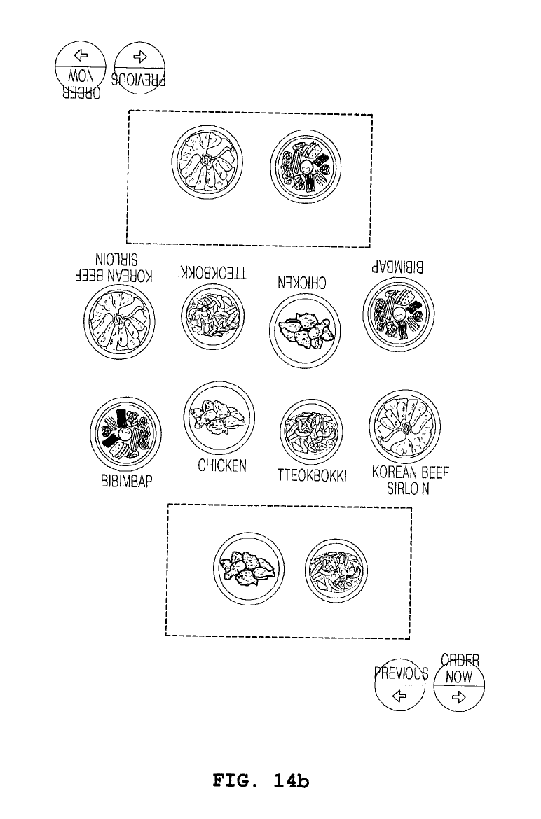

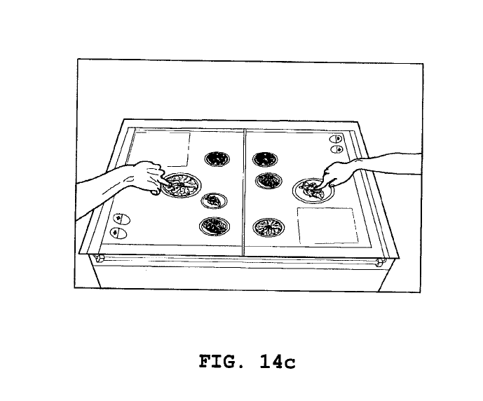

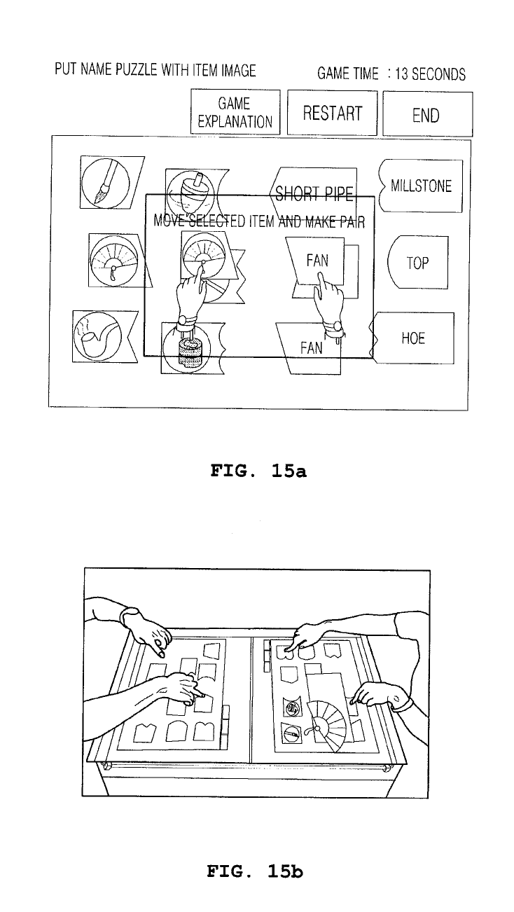

Meanwhile, content produced according to an embodiment of the present invention will be described with reference to FIGS. 14A to 14C below.

In this embodiment, it is assumed that a table has an advantage of thin table environment, where users can have a meal while they sit with placing their legs under the table, and a series of processes whereby users sit down in the restaurant, select and order food has been developed as an application.

FIG. 14A is a view showing a main execution screen of a food ordering content application. The table has a dual structure, which is suitable for a table for two persons, and users can perform a desired operation using touch input or a dragging operation.

FIG. 14B is a view showing an execution screen used to select food. If a user touches a desired food from a food list and then drags it to his/her ordering space, the food is selected. When the user selects the food, information about the selected food is displayed on a left bottom side of the table, so that the user can be sufficiently informed about the food.

FIG. 14C is a view showing an actual execution of the food ordering application. Two of the touch recognition modules 330 recognize touch input generated in respective monitor regions thereof based on the recognition performed by the multiple cameras proposed herein, perform conversion on touch information so that the touch information is suitable to their regions, and then transmit the resulting information to the content server 400. The content server 400, which receives the respective touch information, combines and treats the touch information as a single region, performs a filtering process on the combined touch information and then transmits the resulting information to the connected content clients 220 after performing the filtering process.

Meanwhile, content produced according to another embodiment of the present invention will be described with reference to FIGS. 15A and 15B below.

FIG. 15A is a view showing a main execution screen of a puzzle matching game application. The content of the puzzle matching game can be created using a Flash program, and two applications are executed by executing one application in each monitor in a dual monitor table environment proposed herein.

FIG. 15B is a view showing users enjoying the game in a real environment. Two of the touch recognition modules 330 recognize touch input generated in the respective monitor regions thereof based on the recognition performed by the multiple cameras proposed herein, perform conversion on the touch information so that the touch information is suitable to their regions, and then transmit the resulting information to the content server 400. The content server 400, which receives respective touch information, identifies connection IDs between the touch recognition modules 330 and a game content, and then transmits the touch information corresponding to each region as the game content.

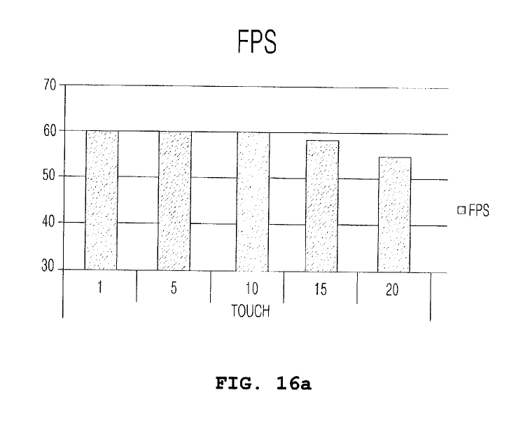

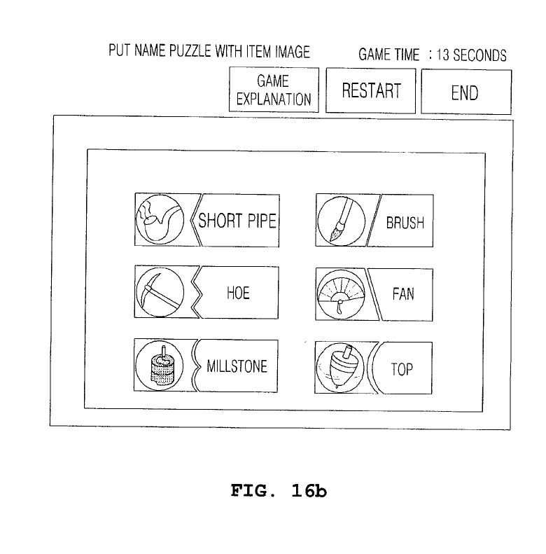

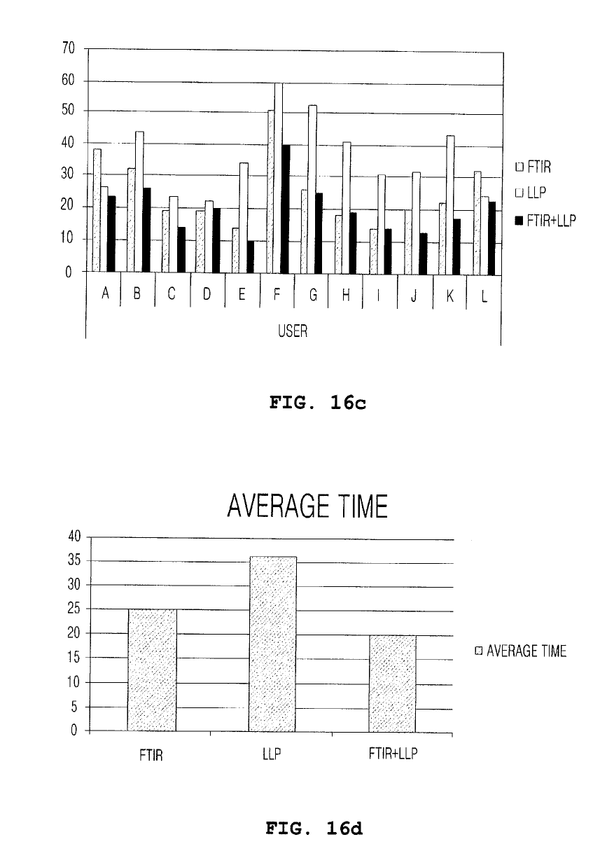

Meanwhile, the evaluation of the performance of the LCD-based tabletop interface system according to the present invention will be described with reference to FIGS. 16A to 16D below.

The recognition performance of the tabletop interface gives an important effect to usability thereof. Therefore, the performance of relevant component of a recognition system is an important factor that affects the performance of the entire tabletop interface. Herein, in order to measure the entire performance of the recognition system, frames per second (FPS) based on the number of user touches is measured.

In this embodiment, an Advanced Micro Device (AMD) Phenom ×4 925 quad-core Central Processing Unit (CPU) of 2.8 GHz with 3.25 G memory, and an Nvidia GeForce GTS250 graphics card are used as hardware used for recognition. A PlayStation (PS) 3Eye camera, on which an 850 nm infrared filter and a wide-angle lens are mounted, is used as a camera for recognizing infrared rays. Since the PS3Eye camera has excellent performance and is inexpensive, the PS3Eye camera is regarded as a camera suitable for manufacturing multi-touch interfaces.

The performance of the PS3Eye Camera is 120 fps (according to experimental results, performance up to 125 fps is achievable) at a resolution of 320×240, and 60 fps (according to experimental results, performance up to 75 fps is achievable) at a resolution of 640×480. Further, since the PS3Eye Camera supports a Universal Serial Bus (USB) port, additional hardware for connecting a camera is not necessary, and the connection can be easily performed.

Herein, in order to measure the recognition performance of multi-touch, the FPS of each camera is measured based on the number of user touches by connecting two cameras to a single Personal Computer (PC). The measurement of FPS is performed while CCV is connected to a content application via a Transmission Control Protocol/Internet Protocol (TCP/IP).

As shown in FIG. 16A, both cameras maintain at 60 fps when a single touch is input, the cameras have 58 fps when 15 touches are input, and the cameras show a respond speed of 55 or more fps until 20 touches are input.

Further, in order to perform user evaluation, an experiment was carried out on twelve men and women in their twenties and thirties who have experience in using touch interfaces. In tabletop interfaces, the recognition rate based on user touch is determined depending on the kind of input systems to be used. For this purpose, the FTIR method and the LLP method are employed herein, and the recognition rate has been measured for each of the FTIR method, the LLP method, and the combination thereof in the experiment.

Further, in the experimental application, a length of time needed to finish the puzzle matching game is measured, the game being completed as shown in FIG. 16B. Users may play the game by using touch input and dragging operations through multi-touch function.

FIG. 16C is a view showing the results of time, which are measured depending on the input methods by user A to user L. The order of using the input methods is random, and the time is measured until the game is finished. When the input system is set to utilize the FTIR method in a first experiment, the average time to complete the game is 25 seconds, which shows a fair recognition rate. However, the users may have to use a lot of energy in order to apply a certain level of strength of touch pressure when they perform the dragging operations, and that weak female experimenters may have trouble to apply enough strength for a touch to be recognized, and thus, have difficulty with the dragging operations.

In order to make up for this, the recognition rate is measured using the LLP input method in a second experiment. In this case, since a high level of touch pressure is not required due to a theoretical feature of the LLP method, unlike the FTIR method, an excellent recognition rate are expected when touch and dragging operations are performed. However, the average time obtained by the experimenters using the LLP input method is 36 seconds, and most of the experimenters take similar or longer time than when using the FTIR method. Actually, when using the LLP method, most experimenters find the dragging operation more convenient to perform but the recognition rate for the touch input operation is not sufficiently high. The reason for such a poorer touch recognition rate is that erroneous touch recognition may be caused by clothes or other fingers around an intended touch point. Therefore, in the experiment, the recognition rate is decreased due to noise.

In the last experiment, the recognition rate is measured by combining the FTIR method and the LLP method. In this case, as shown in FIG. 16D, the total average time of the experimenters is about 20 seconds. Therefore, in the experiment, it is shown that the time required to finish the game is considerably reduced compared to the FTIR method or the LLP method alone.

Therefore, it can be understood that the problem of decreased touch recognition rate attributable to the noise in the LLP method is compensated by a higher touch recognition rate of the FTIR method, and that the problem of decreased dragging recognition in the FTIR method is compensated by a higher dragging recognition of the LLP method. However, since LLP method has the problem of noise, some of the experimenters show a recognition rate similar to or lower than that of the FTIR method. The experimenters are male users who have used the FTIR method for a long period of time, have a bigger finger, and are capable of applying enough touch strength. That is, it is known that normal users, except for certain male users who are familiar with the FTIR method, show a better recognition rate when the input method is a combination of the FTIR method with the LLP method.

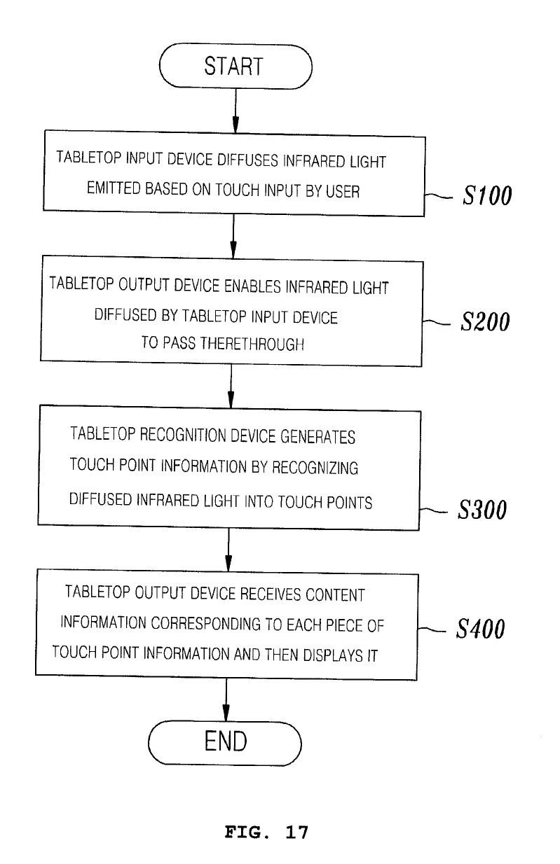

Meanwhile, an LCD-based tabletop interface method according to the present invention will be described with reference to FIGS. 17 to 19 below.

First, referring to FIG. 17, the tabletop input device 100 diffuses infrared light emitted based on touch input by a user in step S100.

Next, the tabletop output device 200 allows infrared light diffused by the tabletop input device 100 to pass therethrough in step S200.

Next, the tabletop recognition device 300 recognizes a touch point according to a touch of the user by generating touch image data based on the infrared light which is diffused by the tabletop input device 100 and passed through the tabletop output device 200, and then generates touch point information based on the touch point in step S300.

The content server 400 transmits the content information corresponding to each piece of the touch point information received from the tabletop recognition device 300 to the tabletop output device 200 so that the LCD panels 210 display the corresponding content information in step S400.

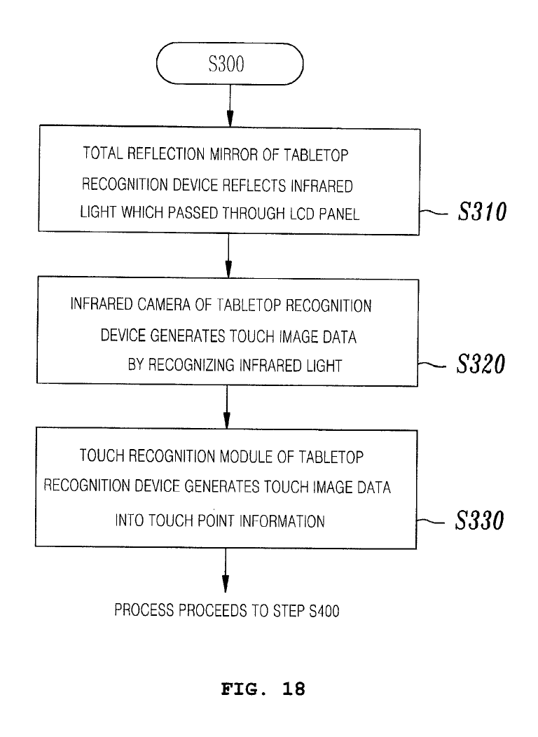

Step S300 of the LCD-based tabletop interface method according to the present invention will be described in detail with reference to FIG. 18 below.

First, each of the total reflection mirrors 310 of the tabletop recognition device 300 reflects the infrared light which passes through the LCD panels 210 of the tabletop output device 200 in step S310.

Next, each of the infrared cameras 320 of the tabletop recognition device 300 generates the touch image data by recognizing the infrared light reflected by the total reflection mirror 310 in step S320.

Further, each of the touch recognition modules 330 of the tabletop recognition device 300 filters off noise included in the corresponding touch image data, and generates the touch point information based on the touch point by tracking the coordinates of each of the touch images from which the noise has been removed and performing calibration for correcting the coordinates in step S330.

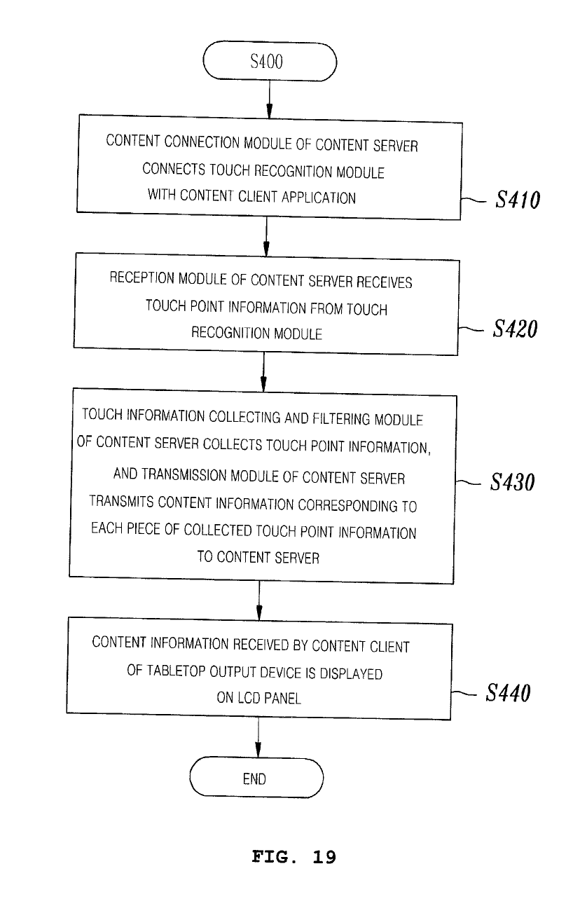

Step S400 of the LCD-based tabletop interface method according to the present invention will be described in detail with reference to FIG. 19 below.

First, the content connection module 410 of the content server 400 generates and manages an ID by connecting the touch recognition module 330 of the tabletop recognition device 300 with the content client application in step S410.

Next, the reception module 420 of the content server 400 receives the touch point information relative to the ID in step S420.

Next, in step S430, the touch information collecting and filtering module 430 of the content server 400 collects and filters all pieces of touch information, and the transmission module 440 performs classification so that the touch information corresponds to content, and then transmits the resulting touch information to the corresponding content clients 220.

Further, the LCD panel 210 of the tabletop output device 200 displays the content information received from each of the content clients 220 in step S440.

As described above, the present invention has an advantage of implementing a tabletop display which enables infrared rays to pass through a plurality of LCD panels, and emits infrared rays when a user performs touch input by coupling FTIR and LLP methods which are multi-touch input methods, thereby realizing a wide and thin output system and implementing table-top display for providing higher resolution and improved image quality.

Further, the present invention has an advantage of providing a tabletop interface which provides a recognition system having a height equal to or less than 20 cm so that the height of a table becomes lower by designing the recognition system to use multiple cameras, thereby achieving a thin and large size table system such that a plurality of users are enabled to share the table and to perform real-time interaction, while the table can function as furniture.

Further, the present invention has an advantage of providing middleware for touch recognition and content interaction based on the use of a plurality of LCDs and a plurality of cameras, thereby providing flexibility and extensibility of a recognition system.

Although the preferred embodiments of the present invention have been disclosed for illustrative purposes, the present invention is not limited to the configurations and operations illustrated and described above. Those skilled in the art will appreciate that various variations and modifications are possible, without departing from the scope and spirit of the invention. Therefore, all appropriate variations, modifications and equivalents should be regarded as being included in the scope of the present invention.

What is claimed is:

1. A tabletop interface system comprising:
a tabletop input device configured to diffuse an infrared light emitted based on at least one touch input from a user;
a tabletop output device configured to enable the diffused infrared light to pass therethrough to display content information corresponding to at least one touch point;
a tabletop recognition device configured to recognize the at least one touch point by generating a touch image data based on the infrared light passing through the tabletop output device and generate touch point information by using the touch image data; and
a content server configured to transmit the content information, which corresponds to the touch point information received from the tabletop recognition device, to at least one content client application.

2. The system according to claim 1, wherein the at least one touch input from the user is generated using a Frustrated Total Internal Reflection (FTIR) input method or a Laser Light Plane (LLP) input method.

3. The system according to claim 1, wherein the tabletop input device comprises:
a plurality of infrared laser emitters configured to emit the infrared light of substantially about 800 nm to substantially about 900 nm; and
a plurality of line generators configured to diffuse the infrared light in a form of a line such that the diffused infrared light has an angle of substantially about 100° to substantially about 110°,
wherein each of the line generators is positioned in a front portion of the corresponding infrared laser emitter and is spaced apart from an upper surface of the tabletop output device by a predetermined distance.

4. The system according to claim 3, wherein the predetermined distance is in a range between substantially about 1 mm and substantially about 5 mm.

5. The system according to claim 1, wherein the tabletop output device comprises:
a plurality of liquid crystal display (LCD) panels each configured to include at least one light guide panel having a square or rectangular shape and a plurality of backlight units, each of which covers a part of an outside surface of the at least one light guide panel, the infrared light diffused by the tabletop input device passing through the plurality of the LCD panels; and
a plurality of content clients each configured to control the content information corresponding to the touch point information to be displayed on the corresponding LCD panel.

6. The system according to claim 1, wherein the tabletop recognition device comprises:
a plurality of total reflection mirrors, each spaced apart by a predetermined distance from a lower portion of an LCD panel of the tabletop output device and configured to reflect the infrared light passing through the LCD panel;
a plurality of infrared cameras each provided under the LCD panel and configured to generate the touch image data by recognizing the infrared light reflected by the total reflection mirrors; and
a plurality of touch recognition modules each configured to filter off a noise included in the touch image data in conformity with a Community Core Vision (CCV) library, and configured to generate the touch point information based on the recognized touch point by tracking coordinates of the touch image data from which the noise is removed and performing calibration to correct the coordinates.

7. The system according to claim 6, wherein each of the total reflection mirrors has an angle of substantially about 25° to substantially about 35° relative to a first side of the tabletop recognition device.

8. The system according to claim 6, wherein each of the infrared cameras comprises a wide-angle lens having a rotational angle of substantially about 100° to substantially about 120° and has an angle of substantially about 40° to substantially about 50° relative to a second side of the tabletop recognition device.

9. The system according to claim 6,
wherein each of the touch recognition modules transmits the corresponding touch point information generated based on the touch image data received from each of the infrared cameras to the content server; and
wherein the content server parses the touch point information into a single form and transmits the resulting information to at least one content client.

10. The system according to claim 1, wherein the touch point information is created in Extensible Markup Language (XML) format to include a unique Identification (ID) number of the touch input, coordinates of the touch point information, a time of an occurrence or a termination of the touch input of the user, and information about tracking a dragging operation of the user.

11. The system according to claim 1, wherein the content server comprises:
a content connection module configured to connect a plurality of touch recognition modules of the tabletop recognition module to a plurality of content clients, each of the touch recognition modules providing the touch point information corresponding to the touch input of the user, and each of the content clients providing the content information based on the touch point information;
a reception module configured to receive the touch point information corresponding to the touch input of the user from the tabletop recognition device;
a touch information collecting and filtering module configured to collect and filter the touch point information received from the touch recognition module of the tabletop recognition device; and
a transmission module configured to transmit the content information to the corresponding content client of the tabletop output device, the content information being classified in accordance with the collected and filtered touch point information.

12. A tabletop interface method comprising:
diffusing, by a tabletop input device, an infrared light emitted based on a touch input of a user;
enabling, by a tabletop output device, the diffused infrared light to pass therethrough;
recognizing, by a tabletop recognition device, at least one touch point of the user by generating a touch image data based on the infrared light, which passes through the tabletop output device, and generating touch point information based on the recognized touch point; and
transmitting, by a content server, content information, which corresponds to the touch point information received from the tabletop recognition device, to the tabletop output device such that the content information is displayed to the user.

13. The method according to claim 12, wherein the recognizing of the touch point of the user comprises:
reflecting, by a plurality of total reflection mirrors of the tabletop recognition device, the infrared light which passes through a plurality of display panels and a plurality of backlight units of the tabletop output device;
generating, by a plurality of infrared cameras of the tabletop recognition device, the touch image data by recognizing the infrared light reflected by the total reflection mirrors; and
filtering off, by a touch recognition module of the tabletop recognition device, a noise included in the touch image data, and generating the touch point information based on the touch point by tracking coordinates of the touch image data from which the noise is removed and performing calibration to correct the coordinates.

14. The method according to claim 12, wherein the transmitting of the content information comprises:
connecting, by a content connection module of the content server, a plurality of touch recognition modules to a plurality of content client applications;
receiving, by a reception module of the content server, the touch point information from the connected touch recognition module;
collecting and filtering, by a touch information collecting and filtering module of the content server, the touch point information, and transmitting the content information, by a transmission module, to corresponding content clients, in accordance with the respective touch point information, the classified content information being classified in accordance with the collected and filtered touch point information; and
displaying, by display panels of the tabletop output device, the content information received from the corresponding content clients.

15. The method according to claim 13, wherein the display panel is a liquid crystal display (LCD) panel.

16. A user interface method using a tabletop display system, the method comprising:
diffusing an infrared light emitted based on a touch input of a user such that the infrared light passes through a display unit of the tabletop display system;
reflecting the infrared light passing through the display unit using a plurality of total reflection mirrors;
generating touch point information by recognizing at least one touch point based on the reflected infrared light; and
displaying content information corresponding to the touch point information.

17. The method according to claim 16, wherein the display unit comprises at least one liquid crystal display (LCD) panel and at least one backlight unit.

18. The method according to claim 16, wherein the generating of the touch point information comprises:
generating a touch image data by recognizing the infrared light reflected by the total reflection mirrors; and
filtering off a noise included in the touch image data in conformity with a Community Core Vision (CCV) library.

19. The method according to claim 18, wherein the generating of the touch point information further comprises:
tracking coordinates of the touch image data from which the noise is removed and performing calibration to correct the coordinates.

20. The method according to claim 16, wherein the displaying of the content information comprises:
receiving, by a content server, the touch point information and providing a corresponding content client with the content information classified in accordance with the received touch point information; and
displaying, by the display unit of the tabletop display system, the content information received from the corresponding content client.
